(19) United States
(12) Patent Application Publication
(10) Pub. No.: US 2013/0087524 A1
(43) Pub. Date: Apr. 11, 2013

(54) Sports Bottle Ball

(71) Applicant: Edward Dean Nuckles, Lynchburg, VA (US)

(72) Inventor: Edward Dean Nuckles, Lynchburg, VA (US)

(21) Appl. No.: 13/648,855

(22) Filed: Oct. 10, 2012

Related U.S. Application Data
(60) Provisional application No. 61/545,439, filed on Oct. 10, 2011.

(51) Int. Cl. A61J 9/06

(52) U.S. Cl. 215/395

(57) ABSTRACT

The present invention is a sports bottle ball, which is a baby bottle holder with the shape and the appearance of a sports ball. In the preferred embodiment, the material composition of the invention is an infant-safe, soft-foamed, non-liquid absorbing, non-toxic, closed-cell synthetic material suitable for infants to touch and hold. The invention has a cavity and a removable sleeve. The removable sleeve is positioned within the cavity. Both the removable sleeve and the cavity allow the invention to accommodate common baby bottle sizes. Specifically, the removable sleeve is to accommodate a smaller diameter whereas the cavity is to accommodate a larger diameter. Furthermore, the outer layer of the foam sports ball comprises a plurality of small protrusions which provide friction to the surface of the foam sports ball. The friction upon the surface of the foam sports ball helps the newborn to grip the invention with more ease.

The current application claims a priority to the U.S. Provisional Patent application Ser. No. 61/545,439 filed on Oct. 10, 2011.

### FIELD OF THE INVENTION

The present invention relates generally to an apparatus for a baby bottle holder. Specifically, the apparatus is a baby bottle holder that has the appearance of a sports ball.

### BACKGROUND OF THE INVENTION

Since the start of human existence, mankind has had an inherent interest in ball-related sports. In pursuit of these ball sports, it has been an ancestral intention to introduce the next generation into the familial culture of the particular chosen ball sport of favor. The human feeling of experiencing the first image or capturing through photographic media a newborn child grasping and familiarizing himself or herself with the chosen sport ball of the prior generations is a moment of exceeding pride, joy, and enthusiasm. It is therefore an object of the present invention to promote the positive emotion of a newborn's anticipated growth and eventual participation in activities known to bring the same joy to past generations within the family. The novelty of a presumed affection for a particular sport will enhance relationships between family members as they follow the development of the infant into his or her true ultimate interests in recreational activities which may or may not ultimately include ball sports. The sibling and family rivalry of favoring a particular ball sport may also result the newborn in having multiple selection of sports bottle ball from which to become exposed, which may further enhance the kindred experience. The present invention accomplishes these objects by providing a bottle holder in shape and overall appearance of a sports ball. Moreover, the bottle holder is scaled to fit standard sizes of baby bottles and to be comfortably gripped by the newborn.

### BRIEF DESCRIPTION OF THE DRAWINGS

FIG. 1 is a front view of the present invention in various alternative embodiments.

FIG. 2 is a top exploded view of the present invention illustrating the removable sleeve and the cavity thereof.

FIG. 3 is a bottom exploded view of the present invention illustrating the removable sleeve and the cavity thereof.

FIG. 4 is a perspective view of the present invention with the baby bottle of a larger diameter situated within the cavity thereof.

FIG. 5 is perspective view of the present invention with the baby bottle of a smaller diameter situated within the removable sleeve, which is situated within the cavity thereof.

FIG. 6 is a top view of the preferred embodiment of the present invention taken along line A-A of FIG. 7.

FIG. 7 is a cross-sectional view of the present invention illustrating a baby bottle of a smaller diameter situated with removable sleeve and the cavity thereof, showing the plane upon which a lateral cross-sectional view is taken and shown in FIG. 6.

FIG. 8 is a top view of the preferred embodiment of the present invention with the removable sleeve situated outside the foam sports ball taken along line B-B of FIG. 9.

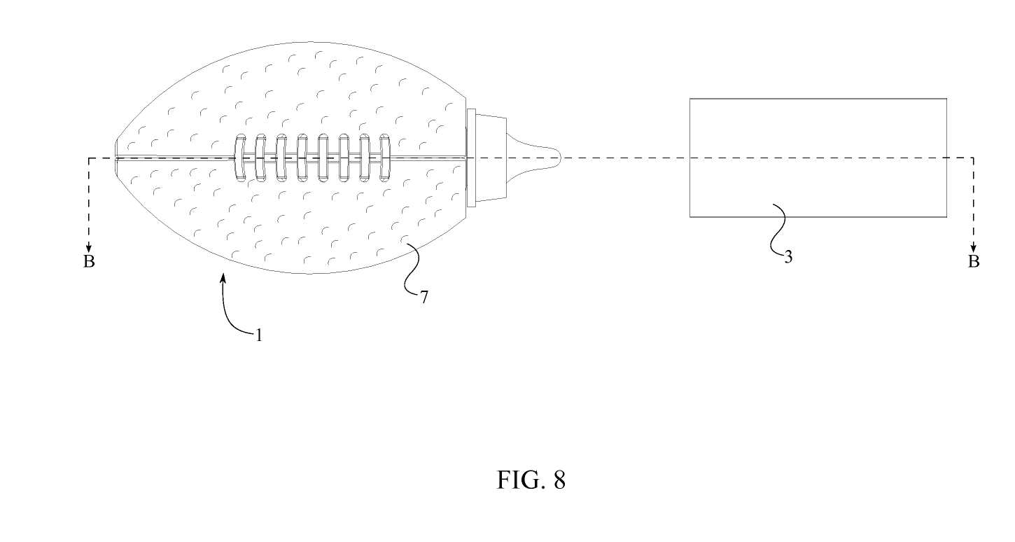

FIG. 9 is a cross-sectional view of the present invention with the baby bottle of a larger diameter situated within the cavity thereof, showing the plane upon which a lateral cross-sectional view is taken and shown in FIG. 8.

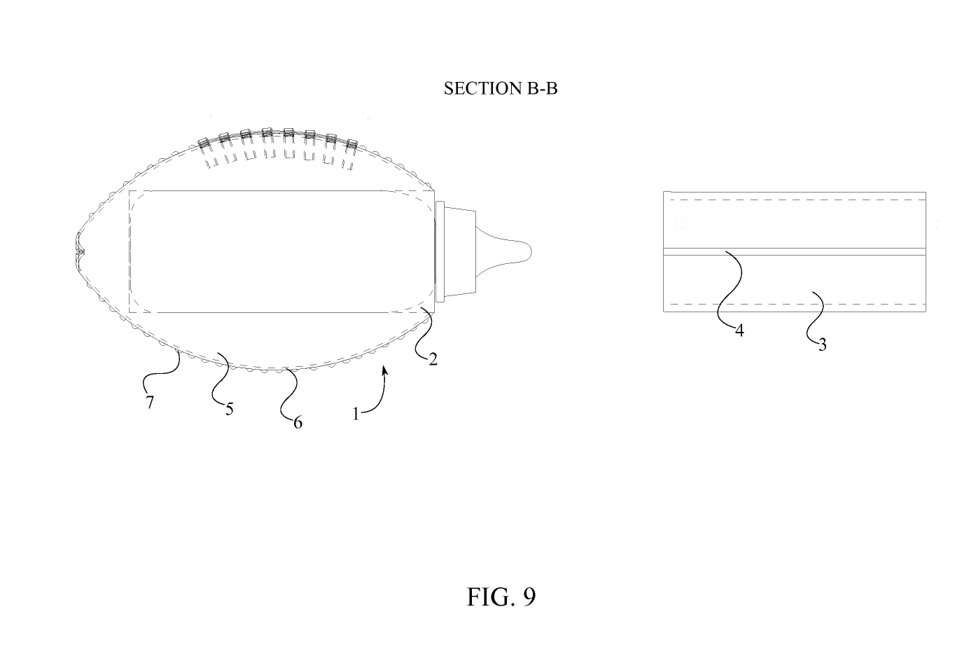

FIG. 10 is a perspective view of the present invention in an alternative embodiment.

FIG. 11 is perspective view of the present invention in another alternative embodiment.

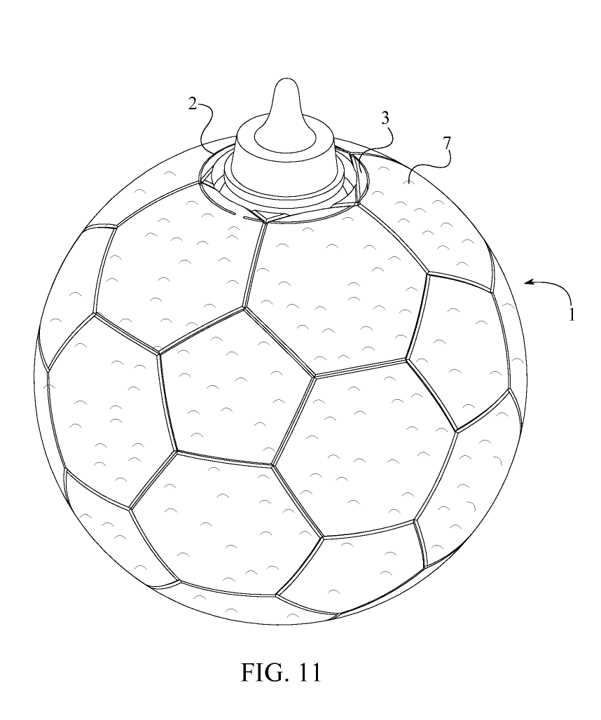

FIG. 12 is a functional view of the present invention being used by an infant.

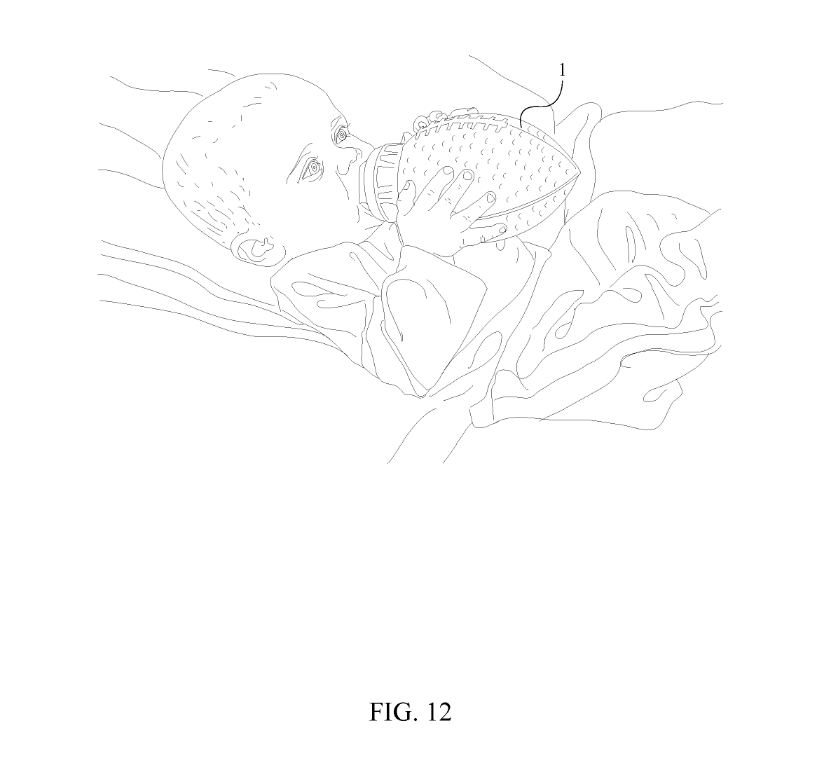

### DETAILED DESCRIPTION OF THE INVENTION

All illustrations of the drawings are for the purpose of describing selected versions of the present invention and are not intended to limit the scope of the present invention.

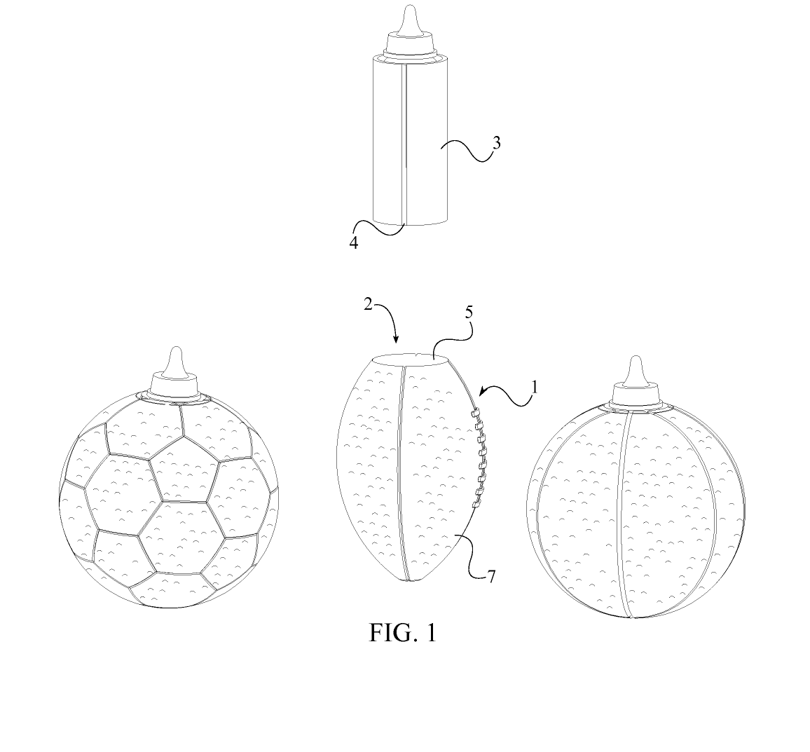

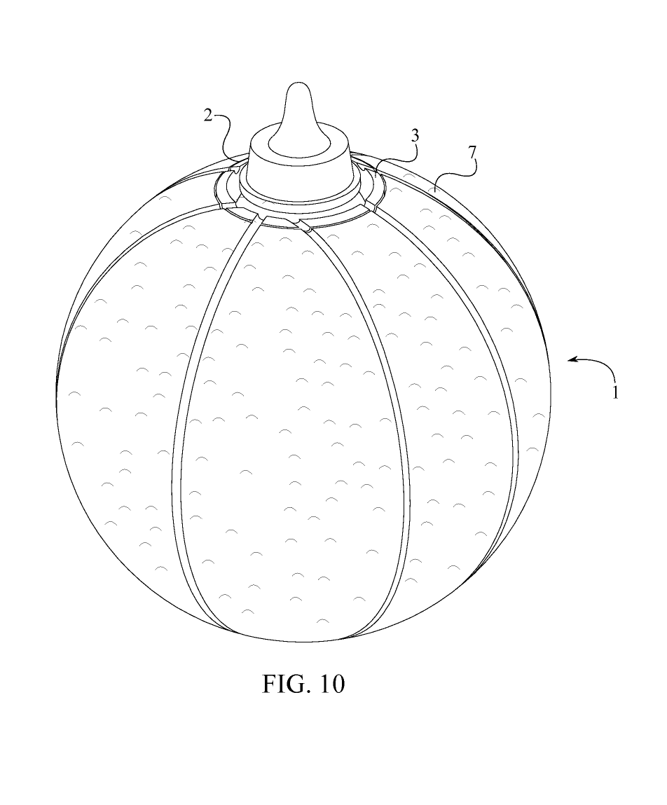

The present invention is a sports bottle ball in shape of a foam sports ball 1 with the appearance of a sports ball. As shown in FIG. 1, the present invention may have the appearance of any desired sports ball, including but not limited to the appearance of any of traditionally popular sports balls such as American football, soccer ball, baseball, softball, cricket ball, golf ball, tennis ball, volleyball, and the like. The shape of the foam sports ball 1 is not necessarily spherical, but the shape of the foam sports ball 1 can be ellipsoidal like that of a football. Furthermore, the foam sports ball 1 is in a scaled size appropriate to be manufactured, constructed, or otherwise built so as to receive a baby bottle. In the preferred embodiment of the present invention, the foam sports ball 1 is in a scaled size appropriate to receive a standard size of baby bottles. The scale of each sports ball may be increased or decreased in size to accommodate a plurality of popular baby bottle sizes such as five-ounce or nine-ounce bottles, both of which are two primary standard baby bottle sizes available in the market today. For example, a golf ball is increased from its normal size to a scale suitable for one of the baby bottle sizes mentioned heretofore. Similarly, a basketball is reduced from its normal size to a scale fitting one of the baby bottle sizes mentioned heretofore. Since each of the two primary standard baby bottle sizes comprises two popular primary diameters, the present invention of a particular size is able to accommodate both primary diameters of each of the two standard baby bottle sizes. For example, the present invention of a particular size is able receive two different primary diameters of the five-ounce baby bottle. Specifically, a removable sleeve 3 of the foam sports ball 1 is to receive the smaller diameter of the two primary diameters whereas a cavity 2 of the foam sports ball 1 is to receive the larger diameter of the two primary diameters. As the infant matures, he or she may need a larger baby bottle size such as the nine-ounce baby bottle, which also exists in two primary diameters like the five-ounce baby bottle. Therefore, the present invention of the particular size would need to be scaled up to accommodate the larger baby bottle size such as the nine-ounce baby bottle. With the foam sports ball 1 properly scaled, the infant is able to grasp the present invention with more ease as shown in FIG. 10. A similar adjustment of scale is followed as necessary for all aforementioned and other sports balls and the like. The preferred embodiment of the present invention is only of a particular scale, but it is understood that any other desired dimensions or scales of the present invention may also be used.

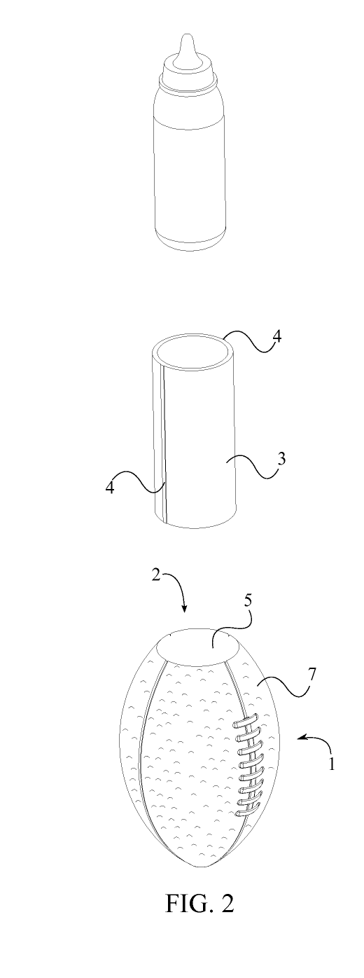

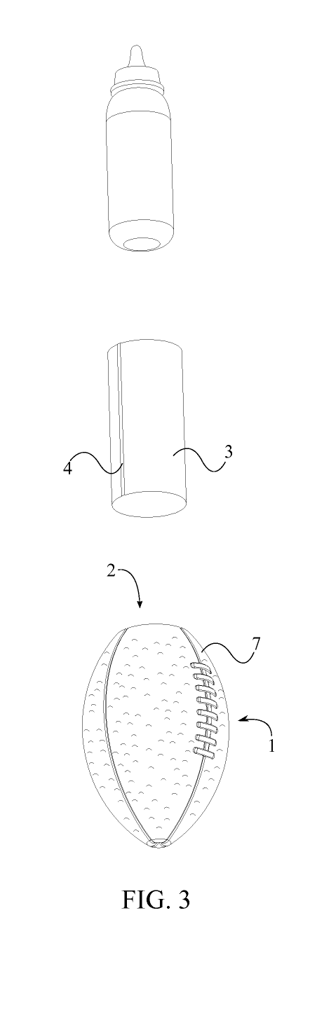

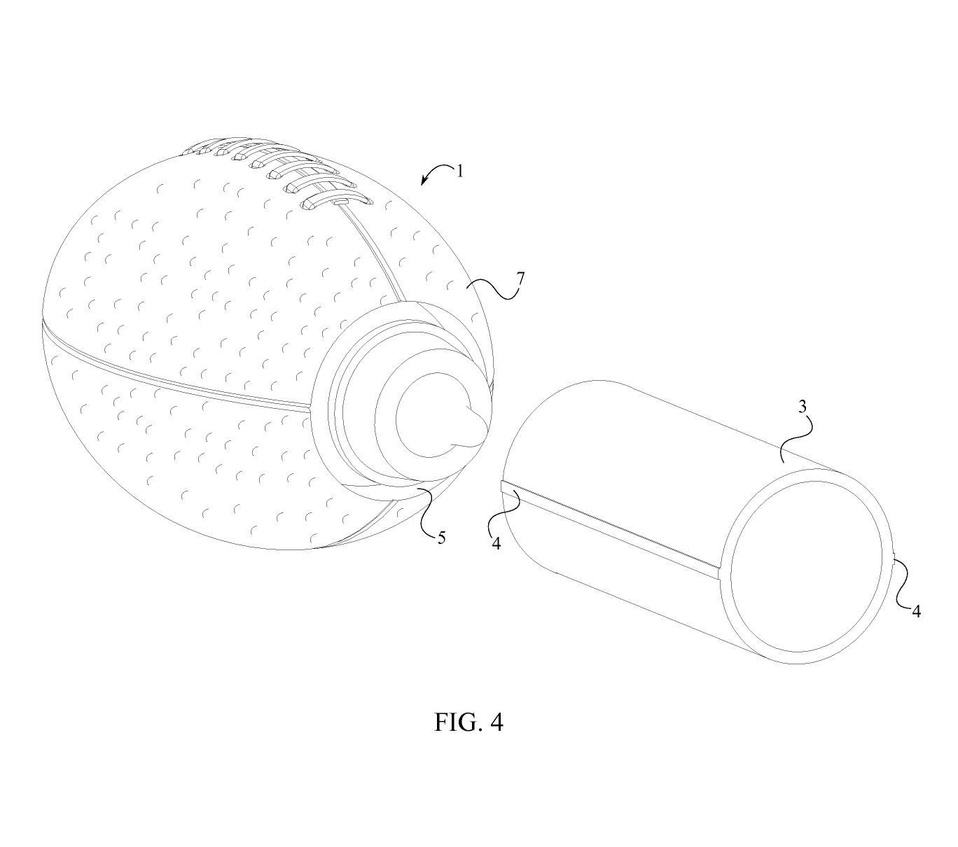

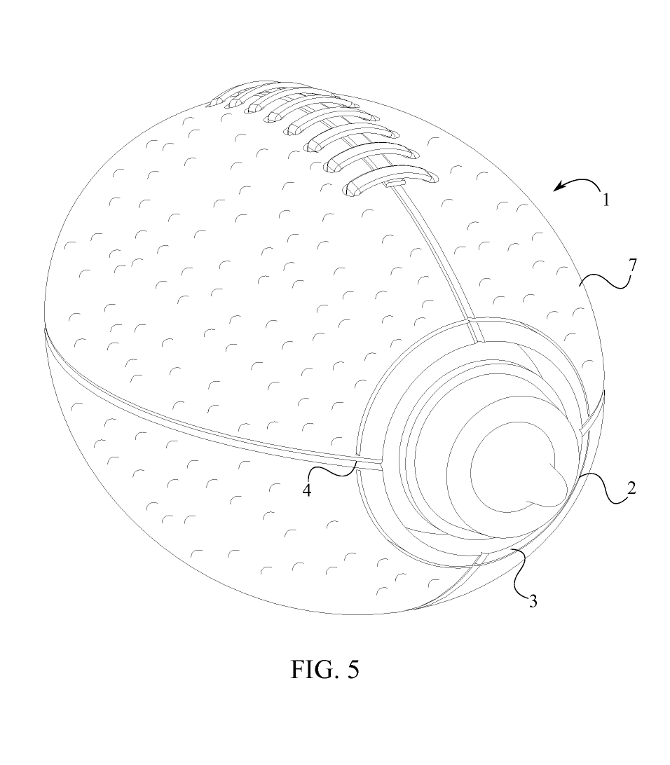

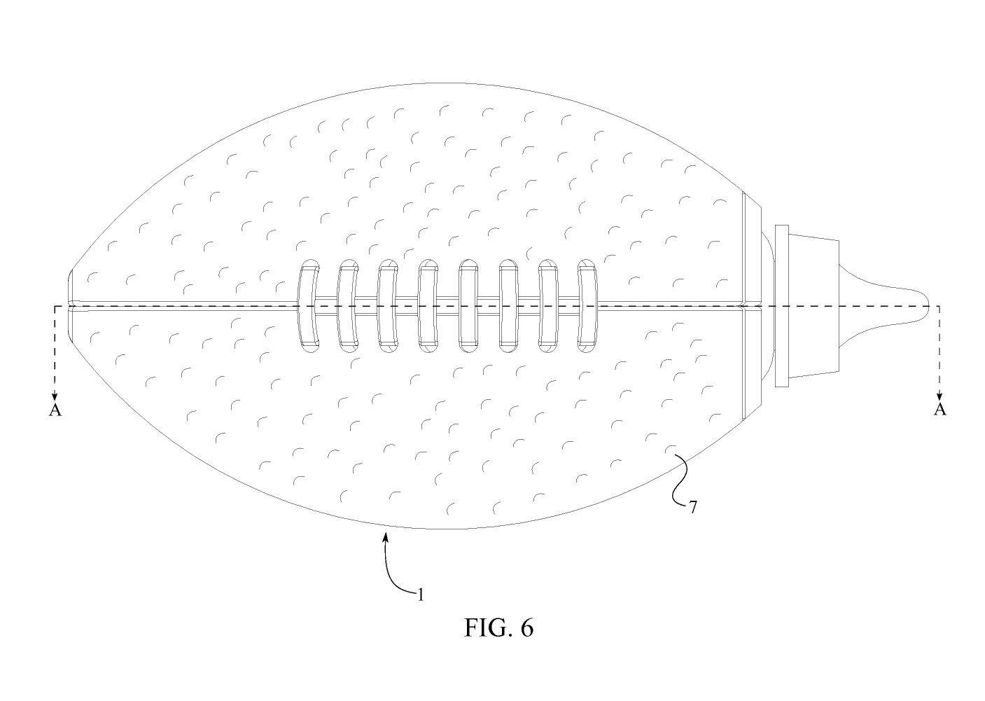

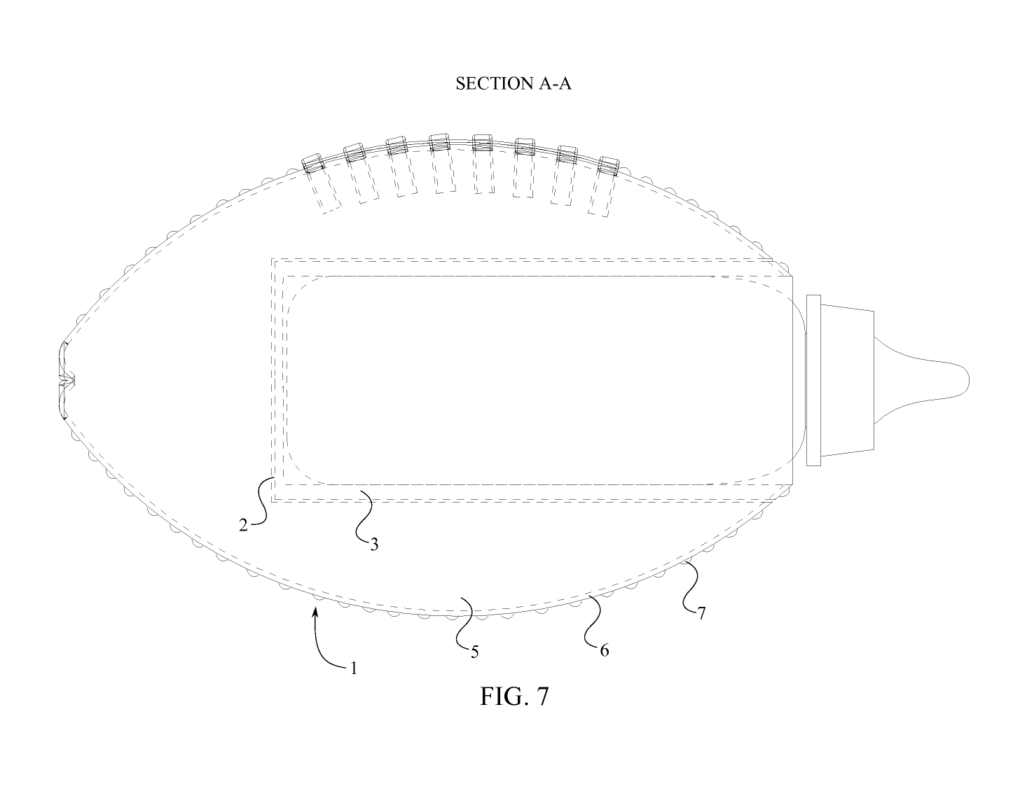

The foam sports ball 1 comprises the cavity 2, the removable sleeve 3, a filled interior 5, an outer layer 6, and a grip surface 7 as shown in FIG. 2 and FIG. 3. Essentially, the removable sleeve 3, the cavity 2, and the filled interior 5 are all situated within the foam sports ball 1. The filled interior 5 is essentially the body of the foam sports ball 1. Therefore, both the cavity 2 and the removable sleeve 3 are positioned within the filled interior 5 of the foam sports ball 1 as shown in FIG. 4, FIG. 5, FIG. 6, and FIG. 7. Specifically, the removable sleeve 3 is situated within the cavity 2, which is situated within the filled interior 5 of the foam sports ball 1. As described hereinafter, the removable sleeve 3 is not entirely separated from the filled interior 5 as the removable sleeve 3 comprises a thickness, which is partially continuous with the filled interior 5 via a pair of tabular portions 4 as shown in FIG. 2 and FIG. 4. The thickness of the removable sleeve 3 provides the removable sleeve an outer diameter and an inner diameter. The inner diameter encompasses the baby bottle whereas the outer diameter is encompassed by the cavity 2. In addition to being positioned within the filled interior 5 of the foam sports ball 1, both of the removable sleeve 3 and cavity are also traversing into filled interior of foam sports ball 1 as described in greater detail hereinafter. During use, the baby bottle is placed bottom end first within either the cavity 2 or the removable sleeve 3, both of which are situated centrally within the foam sports ball 1. The baby bottle is placed within the cavity 2 or the removable sleeve 3 of the filled interior 5 of the foam sports ball 1 until the entire body of the baby bottle is completely encompassed by the foam sports ball 1. While the entire body of the baby bottle is sheathed by the filled interior 5 of the foam sports ball 1, the cap ring and the nipple of the baby bottle are exposed for the baby to access the fluid contained within the baby bottle or for the caregiver to refill the baby bottle.

The cavity 2 is a cylindrically hollow space traversing centrally into the foam sports ball 1. Particularly, the cavity 2 traverses radially inward and through the grip surface 7, the outer layer 6, and into the filled interior 5 of the foam sports ball 1. As shown in FIG. 6 and FIG. 7, the cavity 2 does not traverse through the filled interior 5 of the foam sports ball 1, but along the radius thereof and slightly past the center point thereof. Therefore, the depth of the cavity 2 stops within the filled interior 5. Specifically, the depth of the cavity 2 starts at the outermost circumference of the foam sports ball 1 and ends slightly past the center point of the foam sports ball 1 as shown in FIG. 7. The cylindrical length of the cavity 2 is partially attached to the removable sleeve 3, which is a cylindrically hollow cup. Particularly, the outer cylindrical length of the removable sleeve 3 is in firm contact with the cylindrical length of the cavity 2. The outer circumference of the removable sleeve 3 is completely sheathed by the circumference of the cavity 2. Partially connecting the removable sleeve 3 to the filled interior 5 of the foam sports ball 1 is the pair of tabular portions 4. As shown in FIG. 4, FIG. 5, and FIG. 6, the pair of tabular portions 4 are miniscule bridging tabs connecting the removable sleeve 3 partially to the filled interior 5 of the foam sports ball 1. In the preferred embodiment of the present invention, the width of each of the pair of tabular portions 4 is 3/32 inches. Therefore, the distance between the outer diameter of the removable sleeve 3 and the cavity 2 is ⅛ inches. The pair of tabular portions 4 is situated 180 degrees apart and along the outer circumference of the removable sleeve 3. Furthermore, the pair of tabular portions 4 extend to the full cylindrical length of the removable sleeve 3. Specifically, the pair of tabular portions 4 extend longitudinally from the top of the cavity 2 to the bottom of the cavity 2. The pair of tabular portions 4 serves to temporarily connect the removable sleeve 3 to the cavity 2 and the filled interior 5 of the foam sports ball 1 until the removable sleeve 3 is torn away from the cavity 2 by the user during the initial usage to fit a baby bottle with a larger diameter into the cavity 2 therein. Since the removable sleeve 3 is a cylindrically hollow cup, a baby bottle may be inserted therewithin. In the preferred embodiment of the present invention, the removable sleeve 3 receives a smaller diameter of a standard baby bottle whereas the cavity 2 receives a larger diameter of the standard baby bottle. Both the diameter of the cavity 2 and the diameter of the hollow space within the removable sleeve 3 can be arbitrary as the present invention may be of arbitrary dimensions.

In the preferred embodiment of the present invention, the removable sleeve 3 is of the same foam material as the foam sports ball 1. Specifically, the removable sleeve 3 is die cut to the full depth of the cavity 2 and the full diameter of the cavity 2 with exception of only the pair of tabular portions 4, which are not die cut and are affixed to the filled interior 5 of the foam sports ball 1. The foam of the removable sleeve 3 is compressed within the cavity 2. Therefore, the removable sleeve 3 is secured to the cavity 2 unless the removable sleeve 3 is twisted or pulled out so the pair of tabular portions 4 can be broken and the removable sleeve 3 can be freed from the cavity 2. The compressible and expandable nature of the foam material along with the pair of tabular portions 4 hold the removable sleeve 3 in position within the cavity 2. Furthermore, the compressible and expandable nature of the foam material holds a baby bottle with a smaller diameter within the removable sleeve 3. The diametric size of the cavity 2 is of such a diameter that the foam material of the filled interior 5 becomes compressed when the baby bottle of a larger diameter is inserted therewithin. Naturally, the compression of the foam material snugly holds the baby bottle in position within either the removable sleeve 3 or the cavity 2 during use.

The removable sleeve 3 of the present invention allows the foam sports ball 1 to accommodate the two most popular primary diameters of a standard newborn baby bottle. The production of the foam sports ball 1 is provided to the consumer in one complete unit including the removable sleeve 3. The removable sleeve 3 is to be removed by the consumer to allow the present invention to accommodate a baby bottle with the larger diameter as shown in FIG. 7. Prior research has confirmed the prevalence of two primary baby bottle diameters for each of the two standard baby bottle sizes currently available and in use for infant feeding. The removable sleeve 3 allows for one model product such as the sports bottle ball to fit the majority of newborn consumer product need as the present invention provides the proper fitment to the two most popular baby bottle diameters of either the five-ounce bottle or the nine-ounce bottle in the marketplace.

As the filled interior 5 encompasses both the cavity 2 and the removable sleeve 3, the filled interior 5 is sheathed by the outer layer 6, which completely covers the lateral surface of the foam sports ball 1. Specifically, the outer layer 6 of the foam sports ball 1 serves as the outermost lateral layer, which reinforces the overall structure of the filled interior 5 and consequently the entire structure of the foam sports ball 1 as a whole. Furthermore, the outer layer 6 may serve as a decorative layer comprising either graphic indicia or textual indicia or a combination thereof. Both graphic indicia and textual indicia may be included in the form of embossed or debossed indicia integral to the surface of the outer layer 6. Moreover, both graphic indicia and textual indicia may be included in the form of decals and labels adhesively applied to surface of the outer layer 6. Examples of both graphic indicia and textual indicia include the traditional outward appearance of a sports ball such as the traditional black and white pattern of a soccer ball, ornamental designs such as league logos, team logos, trademarks, brands, and customized text such as the name of the baby. Moreover, the outer layer 6 may possess an exterior color or a combination of a plurality of colors.

In addition to comprising a versatile decorative layer such as the outer layer 6, the present invention also comprises the grip surface 7, which sheathes the outer layer 6.

Particularly, the grip surface 7 of the foam sports ball 1 is comprised of a plurality of small protrusions connected laterally to the outer layer 6. The plurality of small protrusions protrude outward from the outer layer 6. Purposely, the plurality of small protrusions provides the grip surface 7 adequate friction for the infant to grasp thereupon.

The present invention can be manufactured using a combination of materials that are known to be infant-safe in their material composition, including but not limited to non-liquid absorbing, non-toxic, closed-cell, synthetic or similar soft foamed materials. Overall, the material composition of the present invention is suitably safe for infants to hold and touch.

Although the invention has been explained in relation to its preferred embodiment, it is to be understood that many other possible modifications and variations can be made without departing from the spirit and scope of the invention as hereinafter claimed.

What is claimed is:

1. A sports bottle ball comprises,
a foam sports ball;
the foam sports ball comprises a filled interior, a removable sleeve, a cavity, an outer layer and a grip surface;
the filled interior being situated within the foam sports ball;
the cavity being situated within the foam sports ball; and
the removable sleeve being situated within the foam sports ball.

2. The sports bottle ball as claimed in claim 1 comprises,
the cavity being positioned within the filled interior;
the removable sleeve being positioned within the filled interior;
the removable sleeve being positioned within the cavity; and
the removable sleeve being partially connected to the filled interior.

3. The sports bottle ball as claimed in claim 1 comprises,
the removable sleeve traversing into the foam sports ball; and
the cavity traversing into the foam sports ball.

4. The sports bottle ball as claimed in claim 3 comprises,
the cavity traversing into the filled interior; and
the removable sleeve traversing into the filled interior.

5. The sports bottle ball as claimed in claim 1 comprises,
the outer layer sheathing the filled interior;
the outer layer sheathing the cavity; and
the outer layer sheathing the removable sleeve.

6. The sports bottle ball as claimed in claim 1 comprises,
the grip surface sheathing the outer layer.

7. The sports bottle ball as claimed in claim 1, wherein the removable sleeve receives a smaller diameter of a standard baby bottle and the cavity receives a larger diameter of the standard baby bottle.

8. The sports bottle ball as claimed in claim 1, wherein the foam sports ball can be made of any soft-foamed, non-liquid absorbing, non-toxic, closed-celled synthetic material suitably safe for infants to hold and touch.

9. The sports bottle ball as claimed in claim 1, wherein the grip surface comprises a plurality of small protrusions.

10. A sports bottle ball comprises,
a foam sports ball;
the foam sports ball comprises a filled interior, a removable sleeve, a cavity, an outer layer and a grip surface;
the filled interior being situated within the foam sports ball;
the cavity being situated within the foam sports ball;
the removable sleeve being situated within the foam sports ball;
the removable sleeve traversing into the foam sports ball;
the cavity traversing into the foam sports ball;
the removable sleeve being positioned within the cavity; and
the removable sleeve being partially connected to the filled interior.

11. The sports bottle ball as claimed in claim 10 comprises,
the cavity being positioned within the filled interior;
the removable sleeve being positioned within the filled interior;
the cavity traversing into the filled interior; and
the removable sleeve traversing into the filled interior.

12. The sports bottle ball as claimed in claim 10 comprises,
the outer layer sheathing the filled interior;
the outer layer sheathing the cavity;
the outer layer sheathing the removable sleeve; and
the grip surface sheathing the outer layer.

13. The sports bottle ball as claimed in claim 10, wherein the removable sleeve receives a smaller diameter of a standard baby bottle and the cavity receives a larger diameter of the standard baby bottle.

14. The sports bottle ball as claimed in claim 10, wherein the foam sports ball can be made of any soft-foamed, non-liquid absorbing, non-toxic, closed-celled synthetic material suitably safe for infants to hold and touch.

15. The sports bottle ball as claimed in claim 10, wherein the grip surface comprises a plurality of small protrusions.

16. A sports bottle ball comprises,
a foam sports ball;
the foam sports ball comprises a filled interior, a removable sleeve, a cavity, an outer layer and a grip surface;
the filled interior being situated within the foam sports ball;
the cavity being situated within the foam sports ball;
the removable sleeve being situated within the foam sports ball;
the removable sleeve traversing into the foam sports ball;
the cavity traversing into the foam sports ball;
the removable sleeve being positioned within the cavity;
the removable sleeve being partially connected to the filled interior;
the cavity being positioned within the filled interior;
the removable sleeve being positioned within the filled interior;
the cavity traversing into the filled interior; and
the removable sleeve traversing into the filled interior.

17. The sports bottle ball as claimed in claim 16 comprises,
the outer layer sheathing the filled interior;
the outer layer sheathing the cavity;
the outer layer sheathing the removable sleeve; and
the grip surface sheathing the outer layer.

18. The sports bottle ball as claimed in claim 16, wherein the removable sleeve receives a smaller diameter of a standard baby bottle and the cavity receives a larger diameter of the standard baby bottle.

19. The sports bottle ball as claimed in claim 16, wherein the foam sports ball can be made of any soft-foamed, non-liquid absorbing, non-toxic, closed-celled synthetic material suitably safe for infants to hold and touch.

20. The sports bottle ball as claimed in claim 16, wherein the grip surface comprises a plurality of small protrusions.
